(19) United States
(12) Patent Application Publication
(10) Pub. No.: US 2026/0208953 A1
(43) Pub. Date: Jul. 23, 2026

(54) OPTIMIZING ORDER FULFILLMENT PROCESSES

(71) Applicant: Coupang Corp., Seoul (KR)

(72) Inventors: SEUNGHYO LEE, Seoul (KR); Issac Kwon, Seoul (KR); Rahul Umesh Sarnobat, Seoul (KR)

(21) Appl. No.: 19/035,257

(22) Filed: Jan. 23, 2025

(51) Int. Cl. B65G 1/137; G06Q 10/087

(52) U.S. Cl. CPC B65G 1/1373; G06Q 10/087

(57) ABSTRACT

A method of order fulfillment at a fulfillment center includes: identifying, from a list of unfulfilled orders at a fulfillment center (FC), a plurality of item retrieval routes associated with order-items in the FC, where each item retrieval route represents a route for the collection device configured to collect corresponding one or more order-items and is determined based on information associated with the collection device; and identifying, based on location information of the collection device and the information, a subset of item retrieval routes, among the plurality of item retrieval routes, to be assigned to the collection device for a fulfillment process such that an efficiency metric associated with the subset of item retrieval routes satisfies a threshold condition, the fulfillment process including (i) collecting order-items within the subset of item retrieval routes and (ii) delivering collected order-items to a corresponding destination of each item retrieval route.

### TECHNICAL FIELD

The present disclosure relates to a system for order fulfilment at a fulfillment center, and more particularly, a computerized method of order fulfillment at the fulfillment center.

### BACKGROUND

The efficiency of fulfillment center (FC) operations is an important aspect in meeting the increasing demands of online customers and ensuring timely delivery of products. A key process in FCs is the efficient picking of items from inventory, which is important for accurate order fulfillment and the timely packing and shipping of products to customers.

### SUMMARY

The present disclosure is directed to a method of order fulfillment at a fulfillment center.

According to one aspect of the subject matter described in this application, a method of order fulfillment at a fulfillment center can include identifying, from a list of unfulfilled orders at a fulfillment center, a plurality of item retrieval routes associated with order-items in the fulfillment center, where each item retrieval route can represent a route for a collection device configured to collect corresponding one or more order-items and can be determined based on information associated with the collection device; identifying, based on location information of the collection device and the information, a subset of item retrieval route, among the plurality of item retrieval routes, to be assigned to the collection device for a fulfillment process such that an efficiency metric associated with the subset of item retrieval routes satisfies a threshold condition, where the fulfillment process can include (i) collecting order-items within the subset of item retrieval routes from a storage area comprising multiple aisles at the fulfillment center and (ii) delivering collected order-items to a corresponding destination of each item retrieval route, and a number of item retrieval routes in the subset of item retrieval routes can correspond to a number of collection containers associated with the collection device; and generating a signal configured to assign the subset of item retrieval routes to the collection device, the signal configured to instruct the collection device to collect the order-items in the subset of item retrieval routes using a corresponding collection container and store the collected order items in the corresponding collection container.

Implementations according to this aspect can include one or more of the following features. For example, the efficiency metric can be based on a distance traveled per picked unit (DPU), representing a ratio of a total distance traversed by the collection device to collect the order-items in the subset of item retrieval routes to the number of order-items in the subset.

In some examples, identifying the subset of item retrieval routes can include calculating the DPU for various combinations of the plurality of item retrieval routes, and identifying the subset of item retrieval routes as a particular combination among the various combinations, such that the DPU associated with the particular combination satisfies a predetermined condition. In some implementations, the information associated with the collection device can indicate accessibility of the collection device to one or more areas of the fulfillment center and a maximum number of collection containers operable by the collection device.

In some examples, identifying the plurality of item retrieval routes can include determining a maximum number of the plurality of item retrieval routes accessible to the collection device based on the information, and the maximum number of the plurality of item retrieval routes accessible to the collection device can be less than the maximum number of collection containers associated with the collection device. In some implementations, the maximum number of collection containers can be determined based on a capacity of a carrier associated with the collection device, such that the capacity limits the maximum number of collection containers to be handled by the collection device. In some implementations, the subset of item retrieval routes can be restricted from being assigned to another collection device.

According to another aspect of the subject matter described in this application, a computer-implemented system for order fulfillment at a fulfillment center can include at least one processor, and memory coupled to the at least one processor and storing instructions that, based on being executed by the at least one processor, perform operations. The operations can include identifying, from a list of unfulfilled orders at a fulfillment center, a plurality of item retrieval routes associated with order-items in the fulfillment center, where each item retrieval route can represent a route for a collection device configured to collect corresponding one or more order-items and can be determined based on information associated with the collection device; identifying, based on location information of the collection device and the information, a subset of item retrieval routes, among the plurality of item retrieval routes, to be assigned to the collection device for a fulfillment process such that an efficiency metric associated with the subset of item retrieval routes satisfies a threshold condition, where the fulfillment process can include (i) collecting order-items within the subset of item retrieval routes from a storage area comprising multiple aisles at the fulfillment center and (ii) delivering collected order-items to a corresponding destination of each item retrieval route, and a number of item retrieval routes in the subset of item retrieval routes can correspond to a number of collection containers associated with the collection device; and generating a signal configured to assign the subset of item retrieval routes to the collection device, the signal configured to instruct the collection device to collect the order-items in the subset of item retrieval routes using a corresponding collection container and store the collected order items in the corresponding collection container.

Implementations according to this aspect can include one or more of the following features. For example, the efficiency metric can be based on a distance traveled per picked unit (DPU), representing a ratio of a total distance traversed by the collection device to collect the order-items in the subset of item retrieval routes to the number of order-items in the subset.

In some examples, identifying the subset of item retrieval routes can include calculating the DPU for various combinations of the plurality of item retrieval routes, and identifying the subset of item retrieval routes as a particular combination among the various combinations, such that the DPU associated with the particular combination satisfies a predetermined condition. In some implementations, the information associated with the collection device can indicate accessibility of the collection device to one or more areas of the fulfillment center and a maximum number of collection containers operable by the collection device.

In some examples, identifying the plurality of item retrieval routes can include determining a maximum number of the plurality of item retrieval routes accessible to the collection device based on the information, and the maximum number of the plurality of item retrieval routes accessible to the collection device can be less than the maximum number of collection containers associated with the collection device. In some implementations, the maximum number of collection containers can be determined based on a capacity of a carrier associated with the collection device, such that the capacity limits the maximum number of collection containers to be handled by the collection device. In some implementations, the subset of item retrieval routes can be restricted from being assigned to another collection device.

According to another aspect of the subject matter described in this application, a non-transitory recording medium storing a program, where execution of the program can cause one or more computers to perform operations comprising: identifying, from a list of unfulfilled orders at a fulfillment center, a plurality of item retrieval routes associated with order-items in the fulfillment center, wherein each item retrieval route can represent a route for a collection device configured to collect corresponding one or more order-items and can be determined based on information associated with the collection device; identifying, based on location information of the collection device and the information, a subset of item retrieval routes, among the plurality of item retrieval routes, to be assigned to the collection device for a fulfillment process such that an efficiency metric associated with the subset of item retrieval routes satisfies a threshold condition, where the fulfillment process can include (i) collecting order-items within the subset of item retrieval routes from a storage area comprising multiple aisles at the fulfillment center and (ii) delivering collected order-items to a corresponding destination of each item retrieval route, and a number of item retrieval routes in the subset of item retrieval routes can correspond to a number of collection containers associated with the collection device; and generating a signal configured to assign the subset of item retrieval routes to the collection device, the signal configured to instruct the collection device to collect the order-items in the subset of item retrieval routes using a corresponding collection container and store the collected order items in the corresponding collection container.

Implementations according to this aspect can include one or more of the following features. For example, the efficiency metric can be based on a distance traveled per picked unit (DPU), representing a ratio of a total distance traversed by the collection device to collect the order-items in the subset of item retrieval routes to the number of order-items in the subset.

In some examples, identifying the subset of item retrieval routes can include calculating the DPU for various combinations of the plurality of item retrieval routes, and identifying the subset of item retrieval routes as a particular combination among the various combinations, such that the DPU associated with the particular combination satisfies a predetermined condition. In some implementations, the information associated with the collection device can indicate accessibility of the collection device to one or more areas of the fulfillment center and a maximum number of collection containers operable by the collection device.

In some examples, identifying the plurality of item retrieval routes can include determining a maximum number of the plurality of item retrieval routes accessible to the collection device based on the information, and the maximum number of the plurality of item retrieval routes accessible to the collection device can be less than the maximum number of collection containers associated with the collection device. In some implementations, the maximum number of collection containers can be determined based on a capacity of a carrier associated with the collection device, such that the capacity limits the maximum number of collection containers to be handled by the collection device.

### BRIEF DESCRIPTION OF THE DRAWINGS

FIG. 1 is a diagram illustrating an example of a network comprising computerized systems for communications enabling shipping, transportation, and logistics operations.

FIG. 2 is a diagram illustrating an example of a fulfillment center configured to utilize disclosed computerized systems.

FIG. 3 is a flowchart showing an exemplary process for order fulfillment at a fulfillment center.

FIG. 4 is a flowchart showing an example of assignment process.

FIGS. 5A-5C are flowcharts showing an exemplary process for fulfilling order items through a plurality of item retrieval routes.

FIG. 6 is a diagram illustrating a computing system that can be used in connection with computer-implemented methods described in this specification.

FIGS. 7A-7J are diagrams illustrating exemplary display on a collection device.

FIG. 8 is a diagram illustrating an exemplary display on a collection device when some assigned items have not yet been received at the collection containers.

FIGS. 9A-9E are diagrams illustrating exemplary display on a collection device for a manual closing process.

FIG. 10A is a diagram illustrating an example of multiple process paths assigned to multiple collection devices within a fulfillment center.

FIG. 10B is a diagram illustrating an example of multiple process paths assigned to a single collection device within a fulfillment center.

### DETAILED DESCRIPTION

In the current item picking process within certain fulfillment centers (FCs), inefficiencies are evident due to the practice of pickers handling only one tote to collect items in one process path at a time. This method results in increased travel distance for pickers, as they must repeatedly traverse the same aisles to fulfill different orders. By contrast, if a single picker can handle multiple totes (multiple process paths) simultaneously, the total distance traveled could be significantly reduced, thereby enhancing operational efficiency.

The current single-tote approach not only increases the physical strain on pickers but also limits the number of items that can be picked within a given timeframe. This inefficiency is particularly pronounced during peak operational periods, where the demand for rapid order fulfillment is high. The adoption of a multi-tote system could streamline the picking process, allowing pickers to collect items for several orders in one pass through the aisles, thus optimizing their route and reducing redundant travel.

Furthermore, the implementation of a multi-tote picking strategy could improve the overall throughput of the FC. By minimizing the distance traveled per unit picked, the fulfillment center can achieve a higher hourly throughput (HTP) rate. This approach aligns with alternative metrics such as walk time per unit (WTPU) and pick time per unit (PTPU), which emphasize the importance of reducing travel time and increasing picking efficiency. Consequently, the shift to a multi-tote system could address the current inefficiencies and enhance the productivity of the fulfillment center.

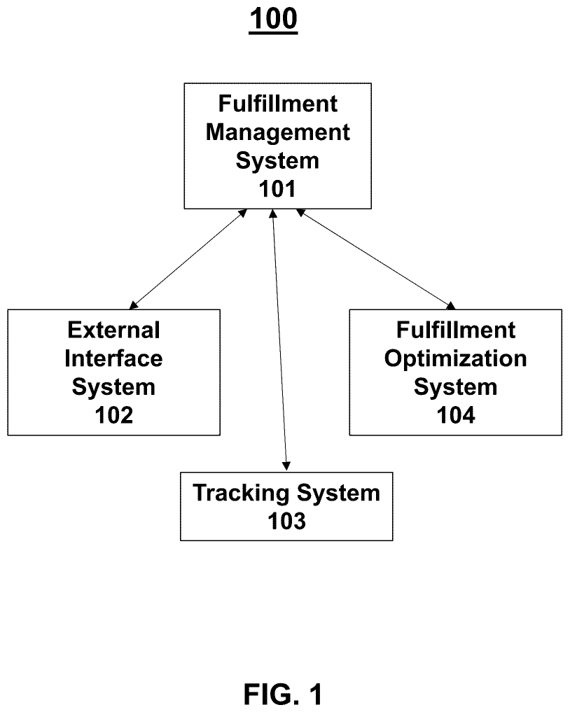

FIG. 1 is a diagram illustrating an example of a network comprising computerized systems for communications enabling shipping, transportation, and logistics operations. A system 100 can include computerized systems for communications enabling shipping, transportation, and logistics operations. For example, the system 100 can include a variety of systems, each of which can be connected to one another via one or more networks. The systems can also be connected to one another via a direct connection, for example, using a cable.

The depicted systems include a fulfillment management (FM) system 101, an external interface system 102, a tracking system 103, and a fulfillment optimization (FO) system 104.

The FM system 101 can be implemented as a computer system that monitors order status and delivery status. For example, the FM system 101 can determine whether an order is past its Promised Delivery Date (PDD) and can take appropriate action, including initiating a new order, reshipping the items in the non-delivered order, canceling the non-delivered order, initiating contact with the ordering customer, or the like. The FM system 101 can also monitor other data, including output (such as a number of packages shipped during a particular time period) and input (such as the number of empty cardboard boxes received for use in shipping). The FM system 101 can also act as a gateway between different devices in system 100, enabling communication (e.g., using store-and-forward or other techniques) between devices such as external interface system 102 and FO system 104.

The external interface system 102 can be implemented as a computer system that enables external users to interact with one or more systems in the system 100. For example, in implementations where the system 100 enables the presentation of systems to enable users to place an order for an item, the external interface system 102 can be implemented as a web server that receives search requests, presents item pages, and solicits payment information. For example, the external interface system 102 can be implemented as a computer or computers running software for receiving and processing requests from external devices, acquire information from databases and other data stores based on those requests, and provide responses to the received requests based on acquired information.

The tracking system 103 can be implemented as a computer system that receives, stores, and forwards information regarding the location of packages containing products ordered by customers. In some implementations, the tracking system 103 can request or store information from web servers operated by shipping companies that deliver packages containing products ordered by customers.

The fulfillment optimization (FO) system 104 can be implemented as a computer system that stores information for customer orders from other systems (e.g., the external interface system 102 and/or the tracking system 103). The FO system 104 can also store information describing where particular items are held or stored. For example, certain items may be stored only in one fulfillment center, while certain other items may be stored in multiple fulfillment centers. In some implementations, certain fulfilment centers may be designed to store only a particular set of items (e.g., fresh produce or frozen products). The FO system 104 can store this information as well as associated information (e.g., quantity, size, date of receipt, expiration date, etc.).

The FO system 104 can also calculate a corresponding PDD (promised delivery date) for each product. The PDD, in some implementations, can be based on one or more factors. For example, the FO system 104 can calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some implementations, the FO system 104 can determine a PDD for each product on a periodic basis (e.g., hourly) and store it in a database for retrieval or sending to other systems (e.g., the external interface system 102, the FM system 101, the tracking system 103). In some implementations, the FO system 104 can receive electronic requests from one or more systems (e.g., the external interface system 102, the FM system 101, the tracking system 103) and calculate the PDD on demand.

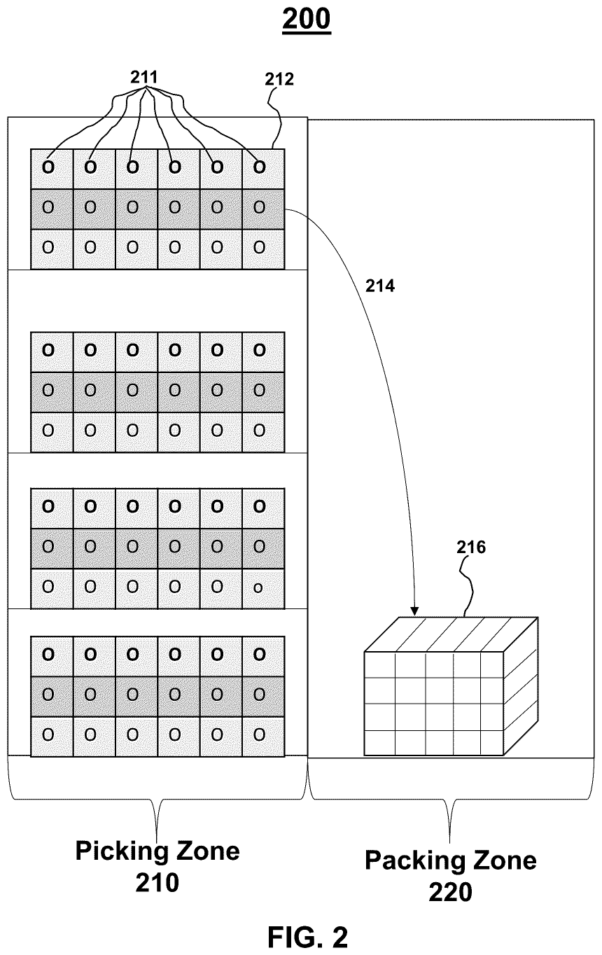

FIG. 2 is a diagram illustrating an example of a fulfillment center 200. The fulfillment center 200 is an example of a physical location that stores items for shipping to customers when ordered. The Fulfillment center (FC) 200 can be divided into multiple zones, each of which are depicted in FIG. 2. These “zones,” in some implementations, can be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some implementations.

A picking zone 210 can be an area of the FC 200 where items 211 are stored on storage units 212. In some implementations, the storage units 212 can comprise one or more of physical shelving, bookshelves, boxes, totes, refrigerators, freezers, cold stores, or the like. In some implementations, the picking zone 210 can be organized into multiple floors. In some implementations, workers or machines can move items into picking zone 210 in multiple ways, including, for example, a forklift, an elevator, a conveyor belt, a cart, a handtruck, a dolly, an automated robot or device, or manually.

A picker may receive an instruction to place (or “stow”) the items in particular spots in the picking zone 210, such as a particular space on a storage unit 212. For example, a picker can scan the item using a mobile device (collection device). The device can indicate where the picker should stow the item, for example, using a system that indicate an aisle, shelf, and location. The device can then prompt the picker to scan a barcode at that location before stowing the item in that location. The device can send (e.g., via a wireless network) data to a computer system indicating that the item has been stowed at the location by the user using the device.

Once a user places an order, a picker can receive an instruction on the device to retrieve one or more items 211 from the storage unit 212. The picker can retrieve the item 211, scan a barcode on the item 211, and place it on a transport mechanism 214. While the transport mechanism 214 is represented as a slide, in some implementations, the transport mechanism can be implemented as one or more of a conveyor belt, an elevator, a cart, a forklift, a handtruck, a dolly, a cart, or the like. The item 211 may then arrive at the packing zone 220.

The packing zone 220 can be an area of the FC 200 where items are received from the picking zone 210 and packed into boxes or bags for eventual shipping to customers.

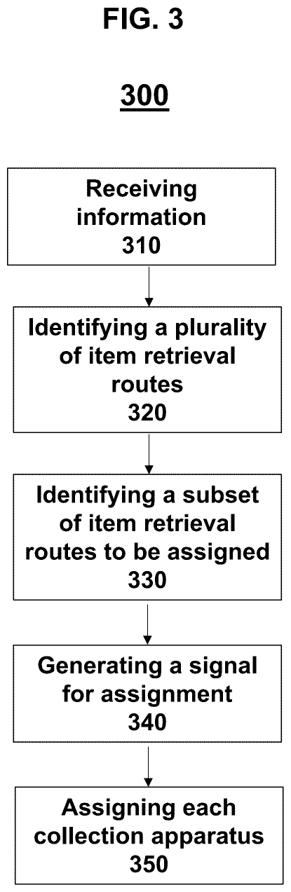

FIG. 3 is a flowchart showing an exemplary process 300 for an order fulfillment process. At least a portion of the process 300 can be performed by various elements of the FO system 104.

Operations of the process 300 can include receiving, from a collection device associated with a picker, a request for a picking assignment to retrieve order-items within the FC 200, where the request can include information regarding accessibility of the collection device to one or more areas of the FC and a maximum number of collection containers operable by the collection device (310). In some implementations, the collection device may not have access to perform picking operations in certain areas of the picking zone 210.

Operations of the process 300 can include identifying, from a list of unfulfilled orders at the fulfillment center, a plurality of item retrieval routes associated with order-items in the FC, where each item retrieval route represents a route for the collection device to collect corresponding one or more order-items and is determined based on the received information (320).

The FO system 104 can pull a list of pending orders that need to be processed, which could originate from various sources such as online sales, bulk shipments, or replenishment orders. The order-items from the list can be divided into a plurality of item retrieval routes (process paths). For example, a picker can travel through a process path within the picking zone 210 to pick up one or more order-items. The FO system 104 can determine a plurality of process paths based on the accessibility of the collection device.

In some implementations, the maximum number of collection containers is determined based on a capacity of a carrier associated with the collection device, such that the capacity limits the maximum number of collection containers to be handled by the collection device. For example, the picker of the collection device may carry a cart that can hold only four collection containers (totes). In this scenario, the number of collection containers, which corresponds to the number of process paths that the collection device can handle, is limited to four.

In some implementations, determining a maximum number of the plurality of item retrieval routes accessible to the collection device is based on the information such that the maximum number of the plurality of item retrieval routes accessible to the collection device is less than the maximum number of collection containers associated with the collection device.

Additionally, as described above, the request can include information about the specific areas of in the picking zone 210 where the collection device has access for operations. This ensures that the FO system 104 assigns process paths that the collection device can access. For example, if the collection device is restricted from certain high-security areas within the picking zone 210, the FO system 104 will exclude those areas from the assigned process paths. This helps optimize the picking process and ensures efficient use of the FO system 104's capabilities.

Operations of the process 300 can include identifying, based on location information of the collection device and the information, a subset of item retrieval routes, among the plurality of item retrieval routes, to be assigned to the collection device for a fulfillment process such that an efficiency metric associated with the subset of item retrieval routes satisfies a threshold condition, where the fulfillment process includes (i) collecting order-items within the subset of item retrieval routes from a storage area comprising multiple aisles at the fulfillment center and (ii) delivering collected order-items to a corresponding destination of each item retrieval route, and a number of item retrieval routes in the subset of item retrieval routes corresponds to a number of collection containers associated with the collection device (330).

For example, the FO system 104 can identify, among the plurality of process paths that the collection device has access to, a subset of process paths to be assigned to the collection device. This allows the picker of the collection device to collect order-items within the subset of process paths in the picking zone 210 and deliver the collected order-items to a corresponding destination in the packing zone 220.

In some implementations, each collection container (tote) is assigned to be delivered to a specific destination within the packing zone 220, ensuring that all items in the collection container arrive at the same destination. This assignment can be optimized based on factors such as the type of items, their destination priority, and the capacity of the packing zone.

Additionally, the FO system 104 can consider the maximum tote count that the picker can carry and the accessibility of the collection device when assigning process paths. This ensures that the picker can efficiently manage multiple totes and process paths simultaneously, optimizing the overall picking and packing process. The FO system 104 can also dynamically adjust the assigned process paths based on real-time data, such as changes in order urgency or picker availability, to maintain optimal efficiency.

In some implementations, the efficiency metric is determined based on a distance traveled per picked unit (DPU), representing a ratio of a total distance traversed by the collection device to collect the order-items in the subset of item retrieval routes to the number of order-items in the subset. For example, the subset of item retrieval routes is identified by calculating the DPU for various combinations of the plurality of item retrieval routes, and identifying the subset of item retrieval routes as a particular combination among the various combinations, such that the DPU associated with the particular combination satisfies a predetermined condition.

For example, the subset of process paths is identified based on an efficiency metric that calculates the distance traveled per picked unit (DPU) for each combination of process paths. The FO system 104 can evaluate different combinations, such as handling two process paths, three process paths, or four process paths. Among these combinations, the system selects the one with the least DPU as the subset of process path.

The FO system 104 can dynamically adjust the combinations based on real-time data, such as changes in order urgency, picker availability, and the current state of the FC 200. This ensures that the selected combination of process paths not only minimizes DPU but also adapts to the operational conditions, enhancing overall efficiency. The FO system 104 can also consider other factors, such as the type of items and their destination priority, to further optimize the picking process.

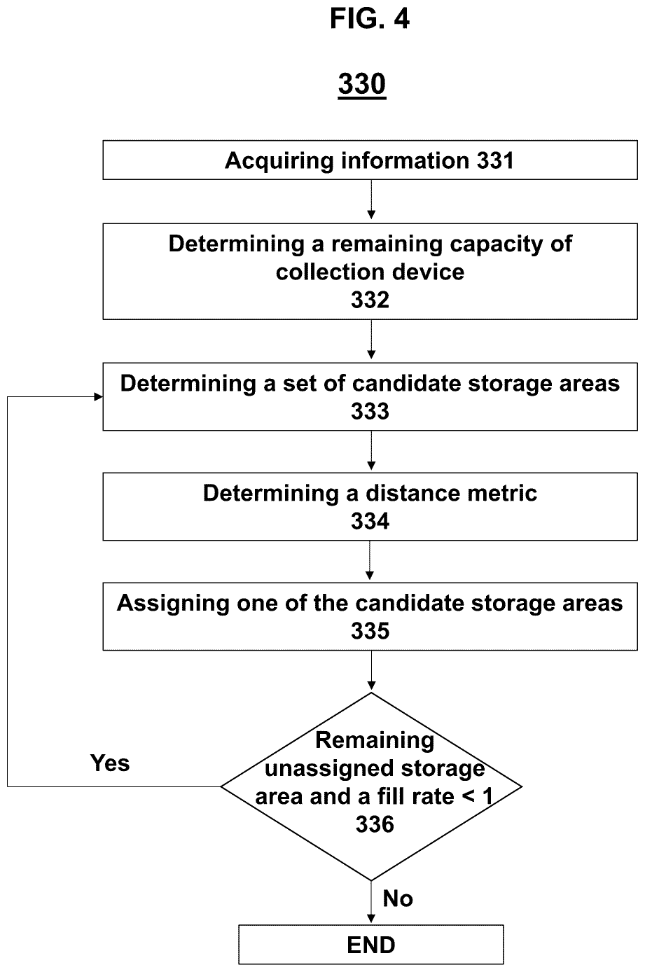

The detailed process 330 for assigning item retrieval routes to the collection device is described with respect to FIG. 4.

Operations of the process 330 can include acquiring, for a particular collection device, information indicative of (i) a location of the corresponding collection device, (ii) a number of collection containers associated with the corresponding collection device, and (iii) a number of process paths assigned to the collection device (331). For example, the request sent from the collection device can include information indicating the location of the collection device, a number of collection containers (totes) can be carried by the cart of the picker, and a number of process paths that are already assigned to the collection device. The FO system 104 can acquire the information from the request.

Operations of the process 330 can include determining, based on (i) the information indicative of the number of collection containers associated with the particular collection device and (ii) the information indicative of the process paths assigned to the collection device, a remaining capacity of the particular collection device (332). For example, the FO system 104 can calculate the number of order-items to be collected from the assigned process paths and determine the extent to which these items fill the totes, thereby determining the remaining capacity.

Operations of the process 330 can include determining, based on the remaining capacity and the list of unfulfilled orders, a set of candidate storage areas within the FC from which at least a subset of the unfulfilled orders that may be collected by the particular collection device (333). For example, the FO system 104 can determine a set of candidate storage areas (supernodes) to which the collection device has access, based on information indicated in the request.

A candidate storage area may correspond to a supernode, which represents a logical or physical aggregation point within the fulfillment network designed to streamline or optimize operations. A supernode can refer to a single aisle within the picking zone 210, or, for a long aisle, two supernodes can be designated to enhance efficiency.

Operations of the process 330 can include determining, for each of the candidate storage areas, a distance metric associated with collection of the corresponding subset of the unfulfilled orders (334). For example, the FO system 104 can determine a total distance to be traversed by the collection device to collect order-items from one or more process paths within the corresponding candidate storage area. The distance metric can include the distance traveled per picked unit (DPU) for each combination of process paths within the corresponding supernode, providing an efficiency measure for the collection operation.

Operations of the process 330 can include assigning, to the particular collection device, one of the candidate storage areas, where the assignment is based on the distance metrics and the information indicative of the location of the particular collection device (335). For example, the FO system 104 can select a supernode with the lowest distance traveled per picked unit (DPU) while also considering the distance the collection device needs to traverse to reach the supernode. Specifically, the assignment ensures that the DPU advantage of the selected supernode is not offset by the travel distance required for the collection device to reach the aisle or entry point of the supernode. This evaluation ensures that the overall efficiency is maximized by balancing the low DPU associated with the supernode and the proximity of the collection device to the assigned storage area.

Operations of the process 330 can include determining whether there are remaining unassigned storage area and a fill rate of at least one collection container is less than a predetermined threshold (336). If it is determined that unassigned storage areas remain and the fill rate is below the predetermined threshold, the process returns to step 333 to identify and assign additional order-items to the collection device. This iterative process continues until all order-items are assigned or the collection containers reach their capacity.

This approach ensures that the collection containers are utilized efficiently, minimizing partially filled containers and reducing the total number of trips required to fulfill the orders. Furthermore, the FO system 104 can consider prioritization rules or operational constraints, such as cutoff times for order completion, to guide the reassignment process dynamically and effectively.

Referring to FIG. 3, operations of the process 300 can include generating a signal configured to assign the subset of item retrieval routes to the collection device, where the signal is configured to instruct the collection device to collect the order-items in the subset of item retrieval routes using a corresponding collection container and store the collected order items in the corresponding collection container (350).

For example, the FO system 104 can assign each collection container to a specific process path within the subset of process paths located in the assigned storage areas. This ensures that order-items from each process path within the designated storage areas are collected into their corresponding collection container, streamlining the organization of items and minimizing cross-path confusion during the collection process.

The FO system 104 can generate a signal to assign the collection device (picker) to collect the order-items in the subset of process paths. This signal can prompt the collection device to inform the picker that the collection device is assigned to retrieve items from the subset of process paths within the picking zone 210. Additionally, the FO system 104 can optimize the assignment based on real-time data, such as the current workload, picker availability, and the urgency of orders. This ensures that the picker can efficiently manage their tasks and that the collection process is streamlined.

Furthermore, the FO system 104 can dynamically adjust the assignments if there are changes in the fulfillment center's conditions, such as new incoming orders or changes in picker availability. This flexibility helps maintain optimal efficiency and ensures that the picking process adapts to varying operational demands.

After the assignment, the FO system 104 can block the subset of item retrieval routes from being assigned to another collection device.

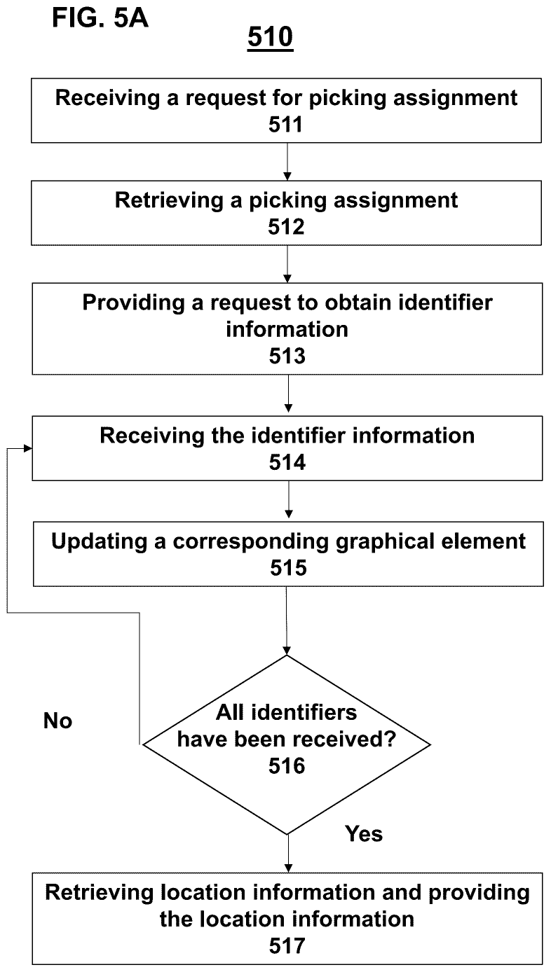

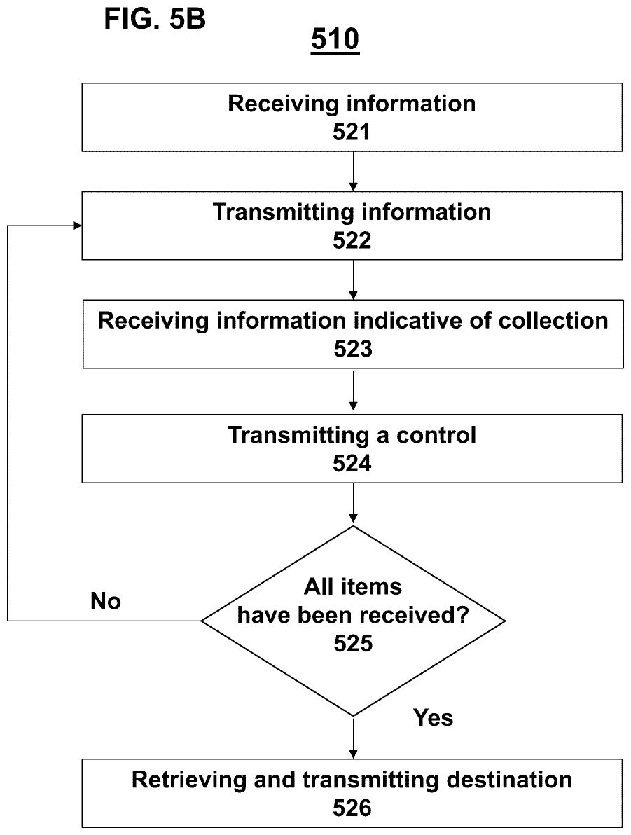

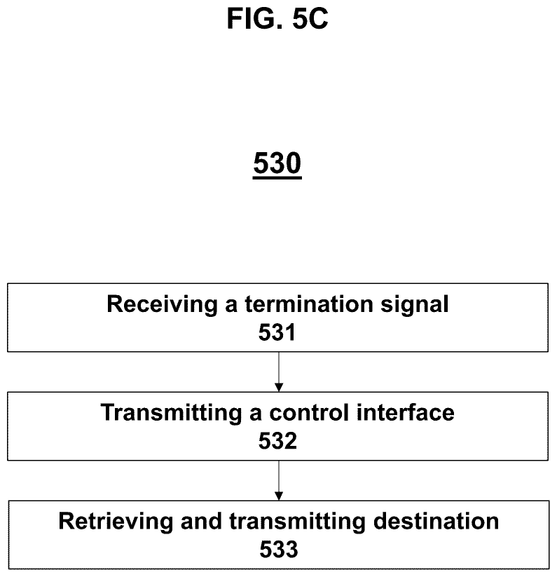

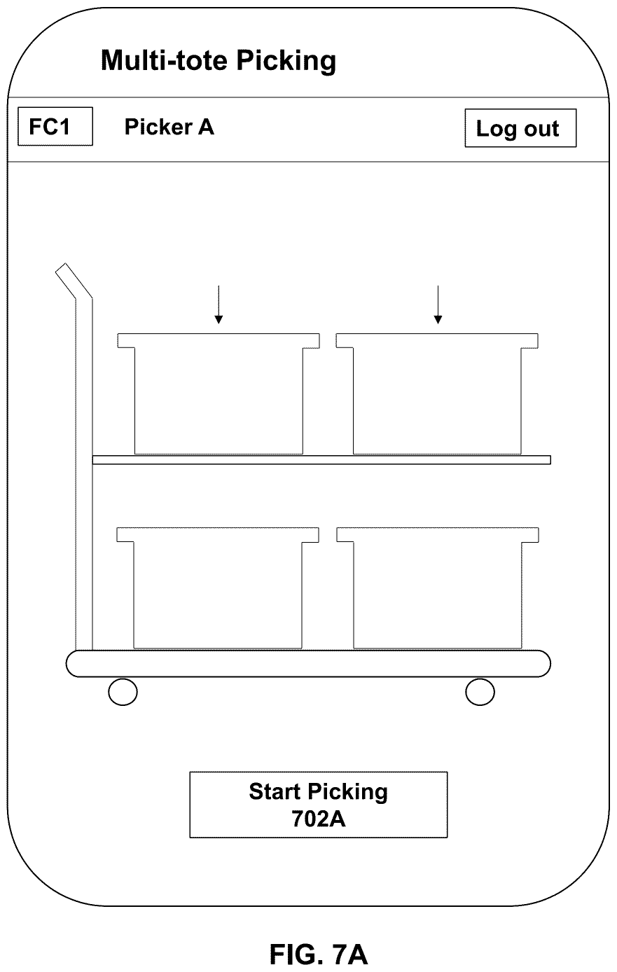

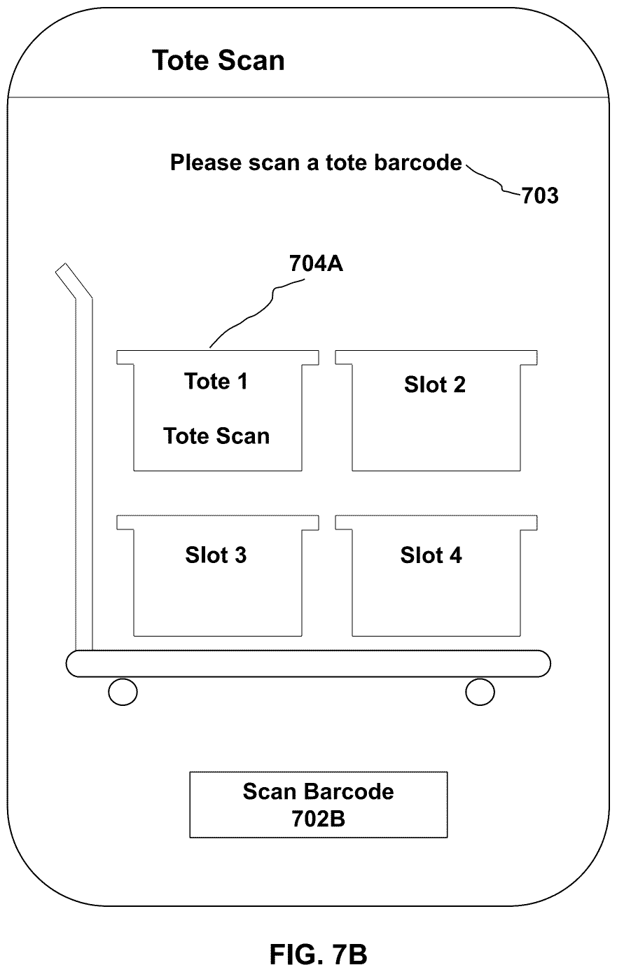

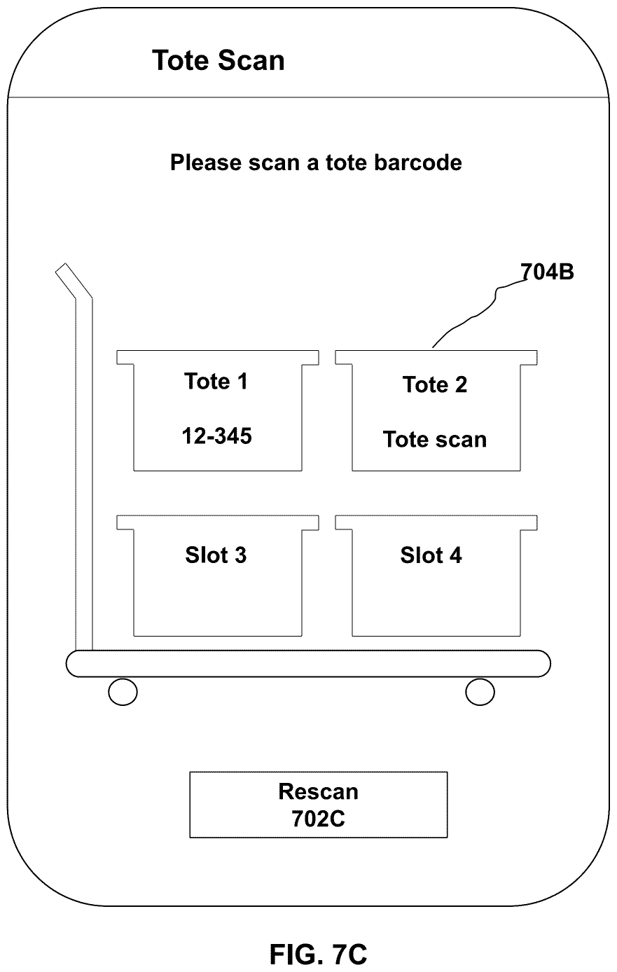

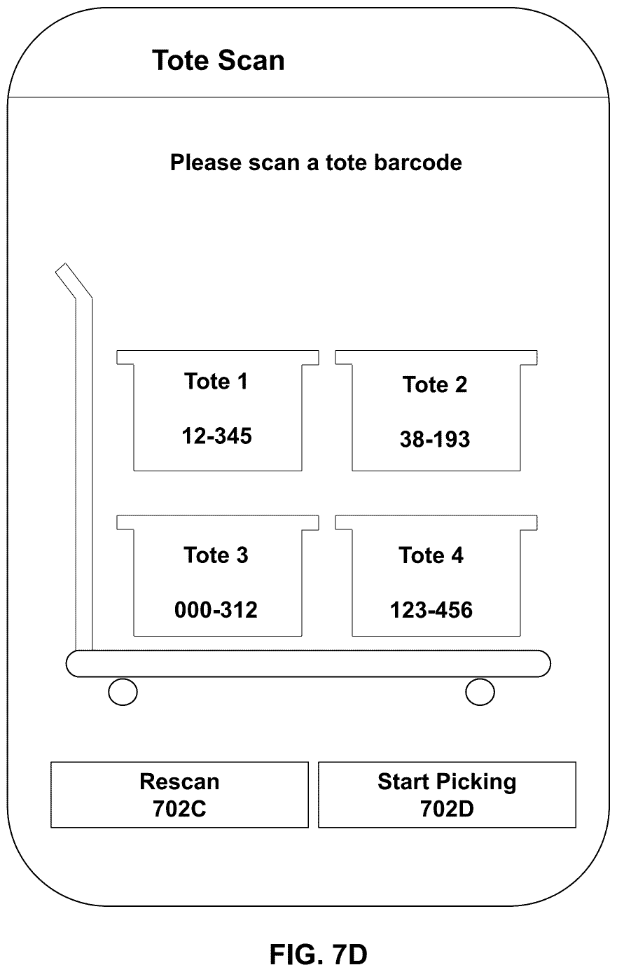

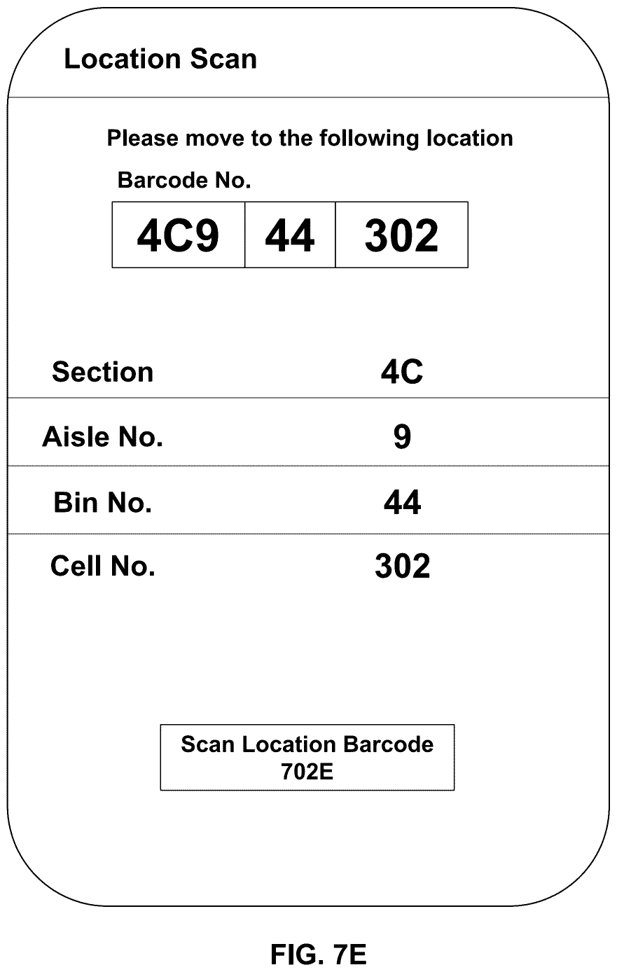

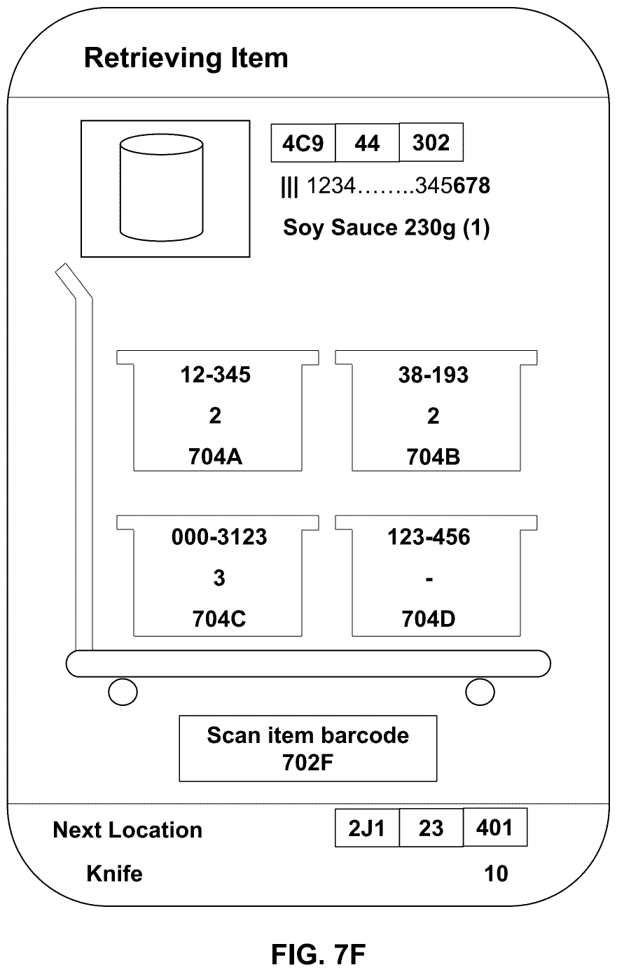

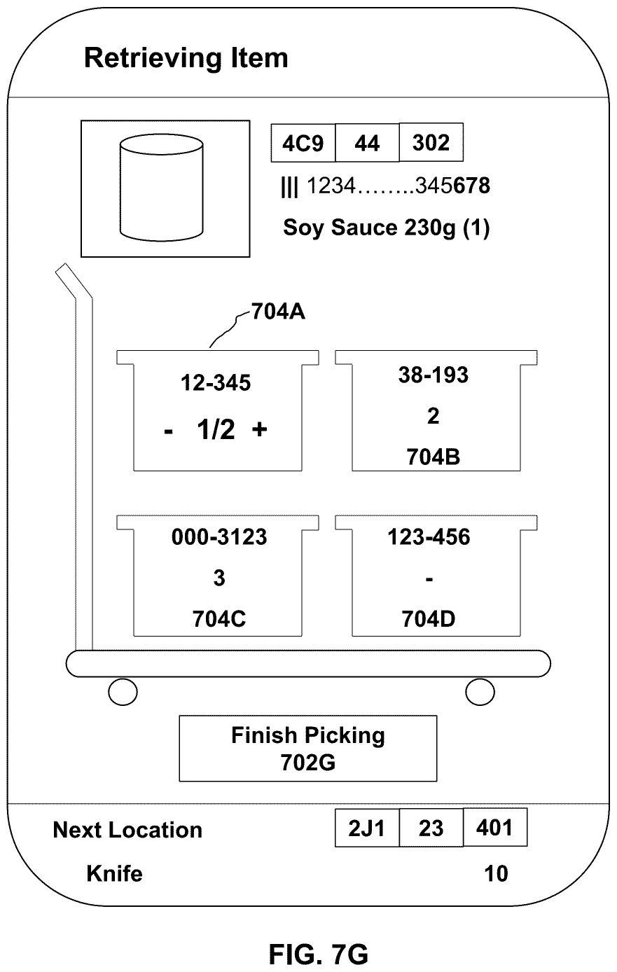

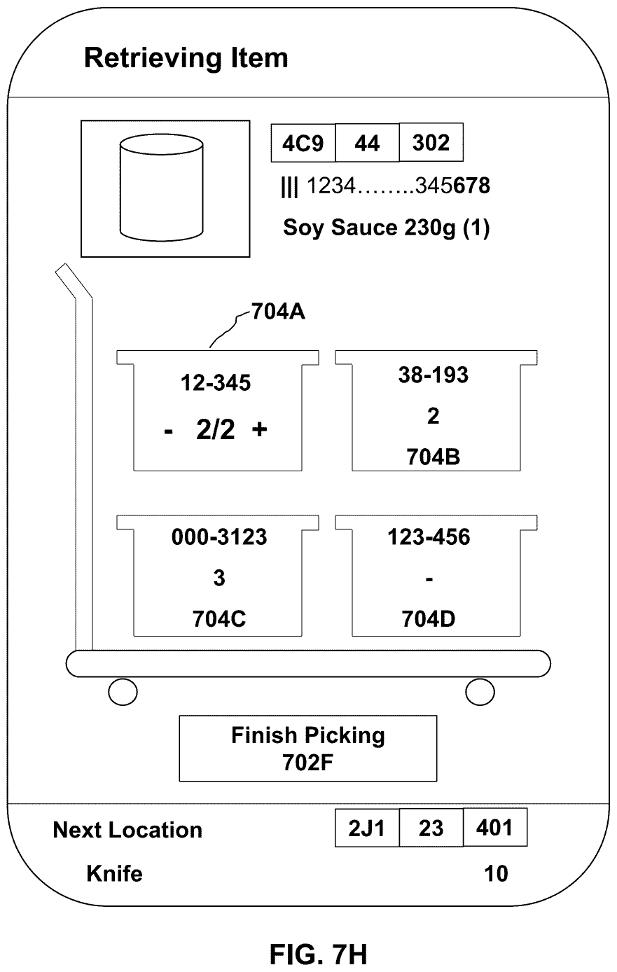

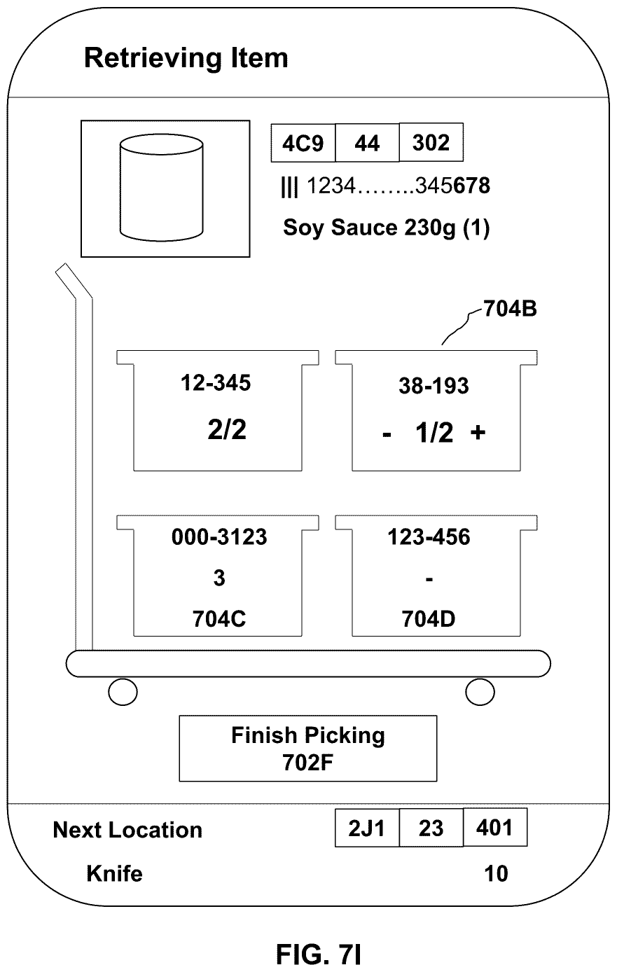

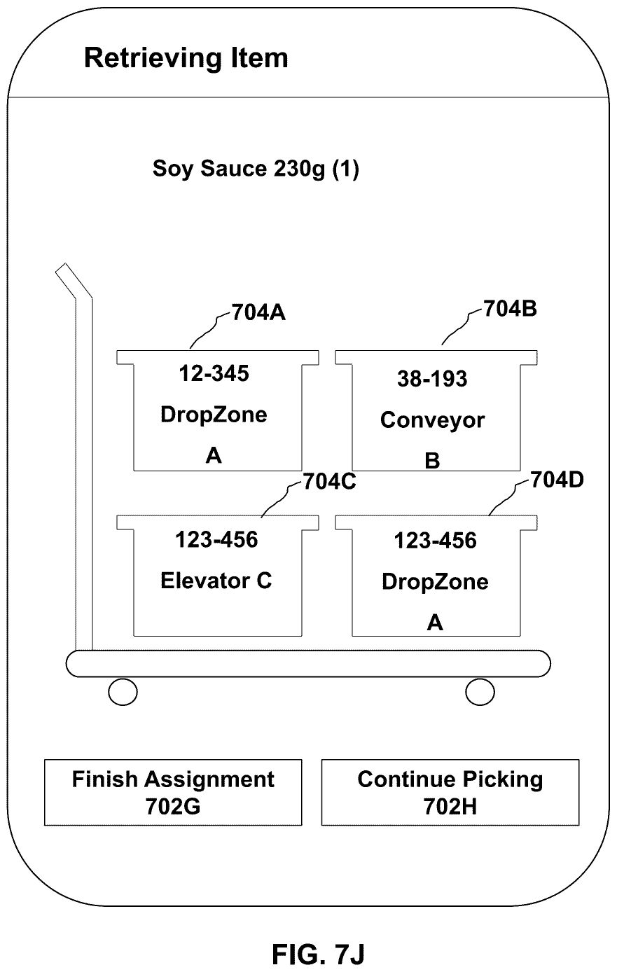

FIGS. 5A and 5B are flowcharts of an exemplary process 510 for fulfilling order items through a plurality of item retrieval routes. For discussion purposes, the exemplary steps of process 510 are described as performed by the FO system 104. In some implementations, different components of the FO system 104 can perform various steps of the methods in a distributed-computing configuration. Further, the operations of the process 510 are discussed in conjunction with FIGS. 7A-7J, which show exemplary displays on the collection device, to help in the description and better illustrate the process.

Operations of the process 510 can include receiving from the collection device, a request for the picking assignment, where the request includes the number of the plurality of collection containers associated with the collection device (511). For example, as depicted in FIG. 7A, the collection device can receive, from a picker, a selectable option 702A to thereby transmit the request for the picking assignment to the FO system 104.

Operations of the process 510 can include retrieving a picking assignment associated with a collection device, wherein the picking assignment includes information regarding (i) a list of unfulfilled orders at the fulfillment center and (ii) a number of a plurality of collections containers associated with the collection device (512), as described above with respect to FIGS. 3 and 4.

Operations of the process 510 can include providing, on a display associated with the collection device, a request to obtain identifier information associated with each of the plurality of collection containers (513). For example, as depicted in 7B, the FO system 104 can display a request 703 on the screen of the collection device to scan four totes. The screen can also indicate a specific tote 704A to be scanned first among the group of totes. The collection device can receive input from a picker selecting an option 702B, which activates the scanner of the collection device to scan a collection container identifier associated with the tote.

In addition or alternatively, the collection device can be configured to perform automated scanning without requiring manual activation by the picker. For example, the scanner can automatically detect and capture the collection container identifiers as the totes are moved into a designated scanning zone or past a sensor integrated with the collection device. In this case, the FO system 104 can validate the scanned identifiers in real-time and provide confirmation or additional instructions on the display without requiring further user input.

Operations of the process 510 can include receiving in response to the request, the identifier information associated with each of the plurality of collection containers (514) and updating, on the display, a corresponding graphical element with the identifier information associated with each of the plurality of collection containers (515). For example, as depicted in FIG. 7C, upon successfully scanning the first tote identifier (12-345), the FO system 104 can update the screen of the collection device to display the scanned collection container identifier and prompt the picker to scan the next tote 704B. If a rescan is required, the collection device can receive input from the picker selecting an option 702C, which reactivates the scanner of the collection device to scan the collection container identifier 704A again.

In some implementations, the graphical elements corresponding to the plurality of collection containers are arranged to reflect a physical arrangement of the plurality of collection containers.

Operations of the process 510 can include determining whether all identifiers of the plurality of collection containers have been received (516). If not all identifiers have been received, the process returns to step 514 to ensure that all tote identifiers are scanned and recorded.

Once all identifiers have been received, the FO system 104 can retrieve location information for a particular item on the list of unfulfilled orders and providing the location information for presentation on the display associated with the collection device (517). In some implementations, as depicted in FIG. 7D, the FO system 104 can update the screen of the collection device to display all scanned collection container identifiers and provide selectable options 702C and 702D. If a rescan is required, the collection device can receive input from the picker selecting option 702C, which reactivates the scanner of the collection device to allow rescanning of a desired collection container identifier. If the picker chooses to proceed with the picking process, the collection device can proceed to the next step upon receiving input from the picker selecting option 702D.

The location information can specify a particular location within the picking zone 210 where the FO system 104 has determined that order-items are to be picked, as described above with reference to FIGS. 3 and 4. For example, the location may correspond to a designated area within the identified supernode where the picking process is to begin. The location can be displayed on the screen of the collection device, as illustrated in FIG. 7E, along with a prompt to navigate to the specified location within the picking zone 210. The screen can further request the user to scan a location barcode, using a selectable option 702E, to confirm the arrival of the collection device at the designated location.

Operations of the process 510 can include receiving information indicative of the collection device being at a location corresponding to the location information (521). For example, a picker can scan, using the selectable option 702E, a barcode of the location identifier to transmit the location identifier to the FO system 104.

Upon receiving the location identifier confirming the arrival of the collection device at the designated location, the FO system 104 can transmit, to the collection device for presentation on the display, information regarding the item and a quantity of the item to be allocated to each collection container (522). For example, as depicted in FIG. 7F, the FO system 104 can provide instructions for picking an item (e.g., soy sauce) from a specified location (e.g., 4C9-44-302). The instructions can indicate that two units of the item are to be placed in tote 704A, two units in tote 704B, and three units in tote 704C.

Operations of the process 510 can include receiving information indicative of collection of the particular item (523). For example, the collection device can scan a barcode attached to the item to confirm that the correct item is ready to be placed into the collection container. Using a selectable option 702F, the picker can initiate the scanning of the item barcode, transmitting the item identifier to the FO system 104. In some implementations, if the scanned item identifier does not match the intended item to be picked, the FO system 104 can transmit a notification to the collection device, alerting the picker that the scanned item is incorrect and should not be picked.

Upon receiving the scan of the item identifier, which confirms that the correct item is ready to be placed into the collection container, the FO system 104 can transmit, to the collection device for presentation of the display, a control configured to indicate a quantity of the item allocated in each collection container (524). For example, as depicted in FIGS. 7G, 7H, and 7I, the control interface can include buttons corresponding to each collection container, such as the tote 704A, or the tote 704B allowing the picker to adjust the received quantity of the item using “+” or “−” buttons to reflect the actual number placed in the container.

Operations of the process 510 can include determining whether all items have been successfully placed in the collection containers (525). If any items remain unplaced, the process returns to step 522 to ensure completion of item allocation to the collection containers. Once all items have been received, the FO system 104 can retrieve destination information associated with each collection container and transmit the retrieved information to the collection device for display (526). For example, as depicted in FIG. 7J, the FO system 104 can display the designated destinations for each collection container on the screen of the collection device. The display can indicate that items in tote 704A and tote 704D are assigned to “DropZone A,” items in tote 704B are assigned to “Conveyor B,” and items in tote 704C are assigned to “Elevator C.”

In some implementations, a picker can use a selectable option 702G to stop working on another picking assignment or a selectable option 702H to work on a new picking assignment.

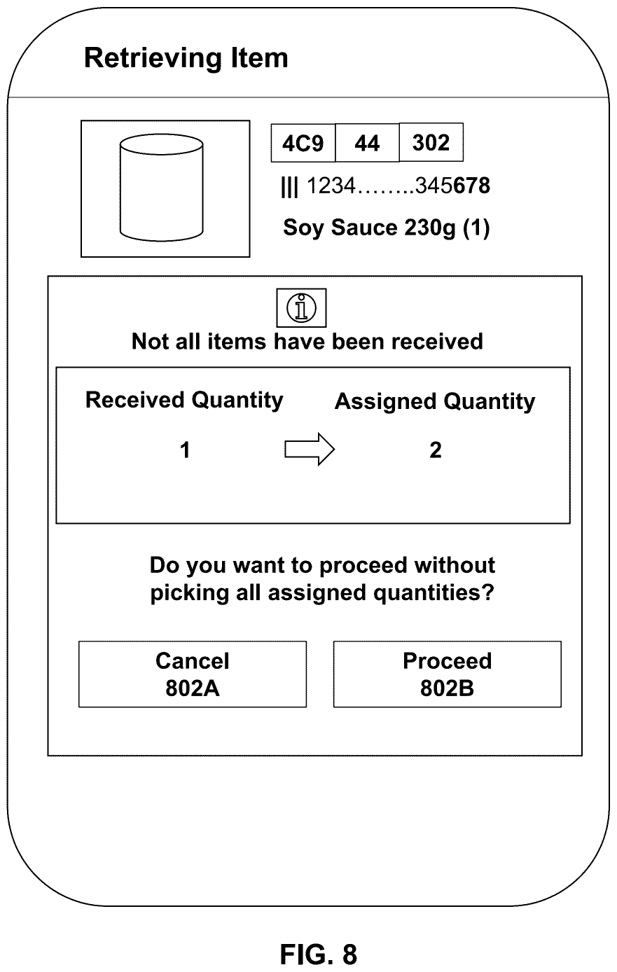

In some implementations, a picker can use a selectable option 702F (depicted in FIG. 7I) to stop working on the current picking assignment even if all items have not been placed in the collection containers. In this scenario, as depicted in FIG. 8, the FO system 104 can provide an interface on the collection device, indicating that the assigned quantity has not been received. The interface can offer selectable option 802A to continue picking the assigned quantity of the item, or selectable option 802B to proceed without collecting all assigned quantities.

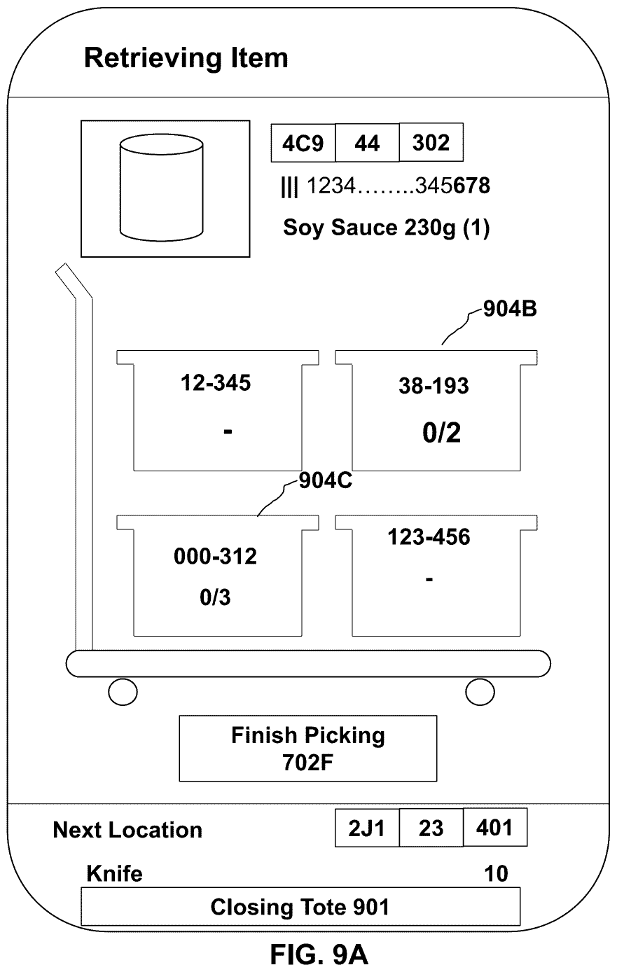

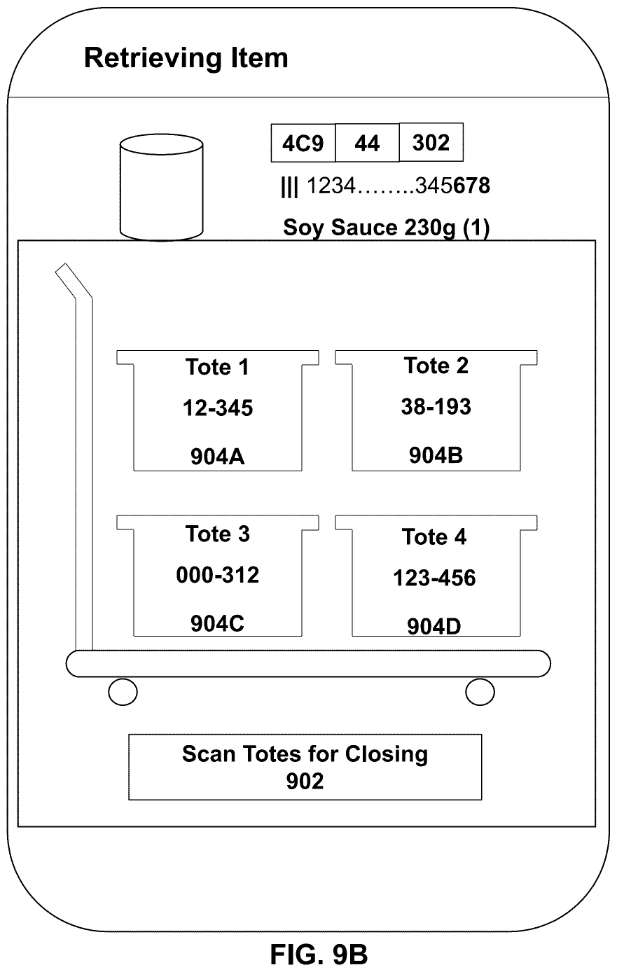

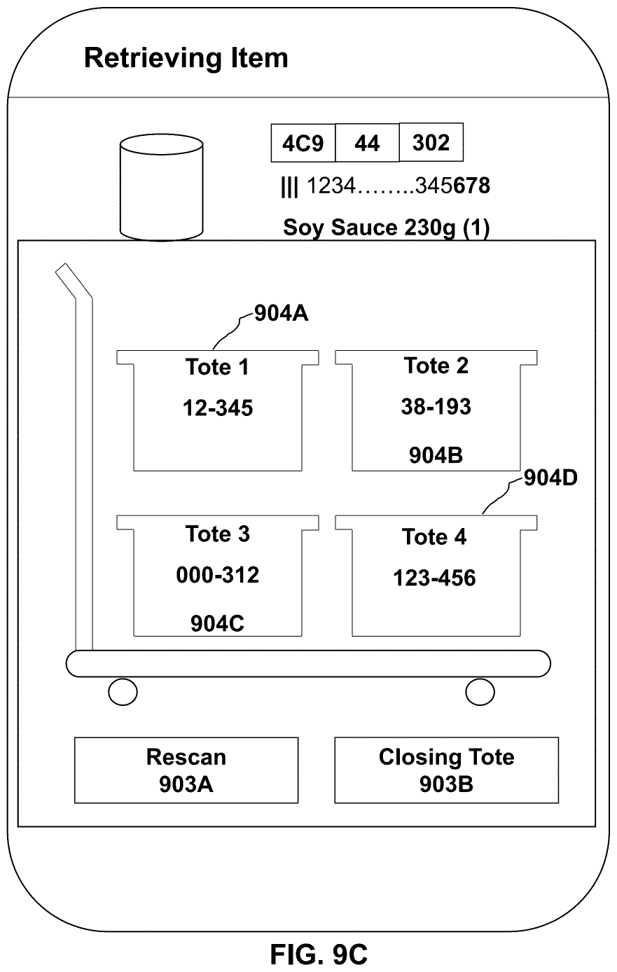

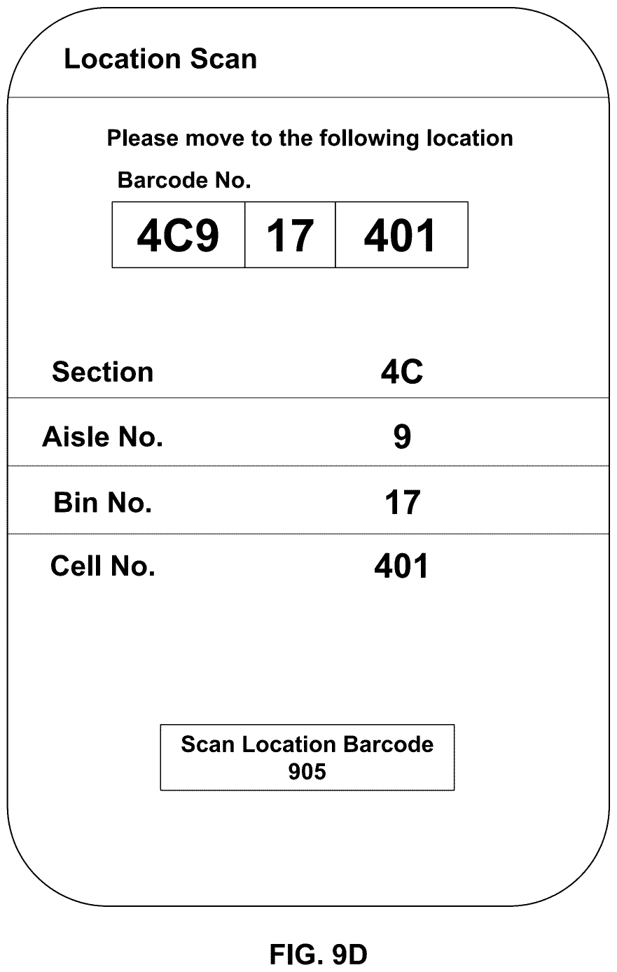

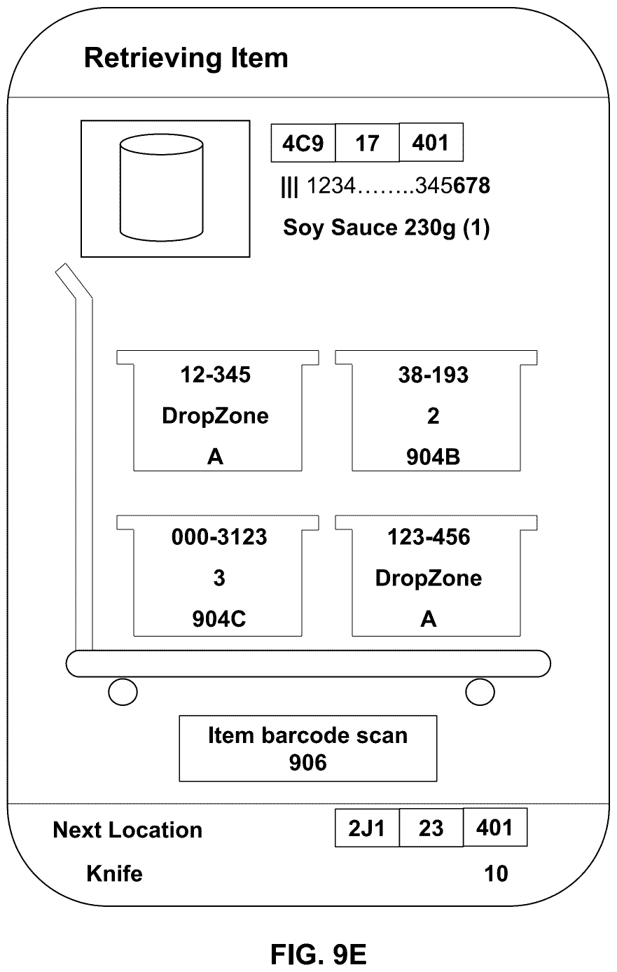

FIG. 5C is a flowchart of an exemplary process 530 for manually closing the picking process. Operations of the process 530 can include receiving a termination signal from the collection device (531). For example, as depicted in FIG. 9A, a picker can use a selectable option 702F to manually complete the picking process, even if not all items have been placed in the collection containers.

Operations of the process 530 can include transmitting, to the collection device for present on the display, a control interface for each collection container (532). The control interface enables the picker to indicate one or more collection containers to be closed for receiving items. For example, as depicted in FIGS. 9B and 9C, a picker can select the tote 904A and the tote 904D to be closed and use a selectable option 902 to scan the selected totes for closure. After all selected totes are scanned, the picker can use a selectable option 903B to confirm the manual closure of the totes.

In some implementations, the FO system 104 can provide, to the collection device for present on the display, location information for the collection device to retrieve items to totes that are not selected to be closed (see FIG. 9D).

Operations of the process 530 can include retrieving destination information for each of the one or more collection containers indicated to be closed and transmitting, to the collection device for presentation on the display, the destination information for those collection containers (533). For example, as depicted in FIG. 9E, the FO system 104 can provide, on the screen of the collection device, destinations for the manually closed collection containers on the screen of the collection device. In this scenario, items in tote 704A and tote 704D are assigned to “DropZone A.”

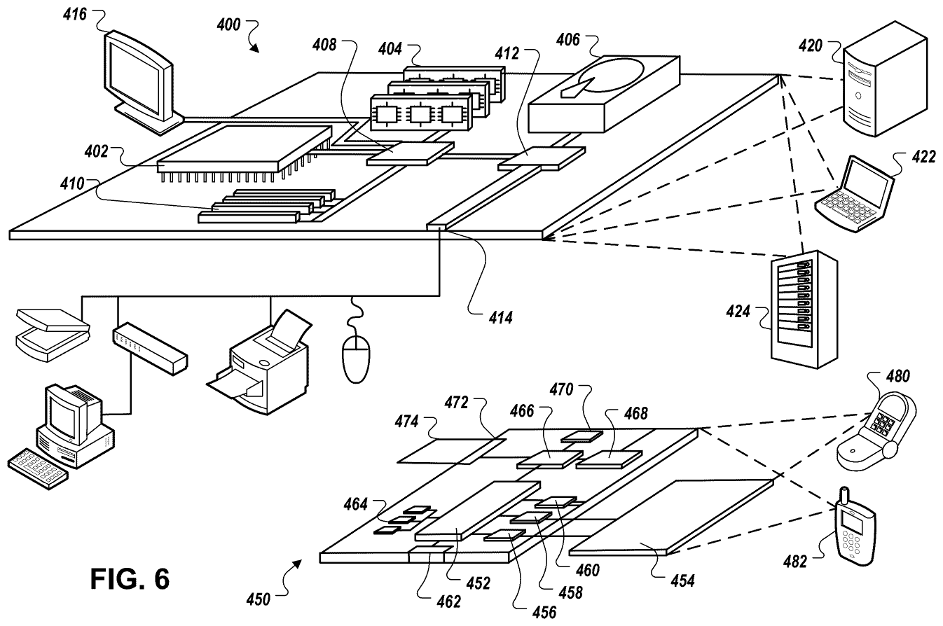

FIG. 6 shows an example of a computing device 400 and a mobile computing device 450 (also referred to herein as a wireless device) that are employed to execute implementations of the present disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 400 and/or the mobile computing device 450 can form at least a portion of the application installation environment described above.

The computing device 400 includes a processor 402, a memory 404, a storage device 406, a high-speed interface 408, and a low-speed interface 412. In some implementations, the high-speed interface 408 connects to the memory 404 and multiple high-speed expansion ports 410. In some implementations, the low-speed interface 412 connects to a low-speed expansion port 414 and the storage device 404. Each of the processor 402, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of a computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 402, perform one or more methods, such as those described above. The instructions can also be stored by one or more storage devices, such as computer-readable or machine-readable mediums, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 414 through a network adapter. Such network input/output devices may include, for example, a switch or router.

The computing device 400 may be implemented in a number of different forms, as shown in the FIG. 6. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing devices 400 and the mobile computing device 450, and an entire system may be made up of multiple computing devices communicating with each other. The computing device 400 may be implemented in the plurality of systems described with respect to FIGS. 1-5 and 7-10.

The mobile computing device 450 includes a processor 452; a memory 464; an input/output device, such as a display 454; a communication interface 466; and a transceiver 468; among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate. In some implementations, the mobile computing device 450 may include a camera device(s) (not shown).

The processor 452 can execute instructions within the mobile computing device 450, including instructions stored in the memory 464. The processor 452 may be implemented as a chipset of chips that include separate and multiple analog and digital processors. For example, the processor 452 may be a Complex Instruction Set Computers (CISC) processor, a Reduced Instruction Set Computer (RISC) processor, or a Minimal Instruction Set Computer (MISC) processor. The processor 452 may provide, for example, for coordination of the other components of the mobile computing device 450, such as control of user interfaces (UIs), applications run by the mobile computing device 450, and/or wireless communication by the mobile computing device 450.

The processor 452 may communicate with a user through a control interface 458 and a display interface 456 coupled to the display 454. The display 454 may be, for example, a Thin-Film-Transistor Liquid Crystal Display (TFT) display, an Organic Light Emitting Diode (OLED) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a Single in Line Memory Module (SIMM) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 452, perform one or more methods, such as those described above. The instructions can also be stored by one or more storage devices, such as one or more computer-readable or machine-readable mediums, such as the memory 464, the expansion memory 474, or memory on the processor 452. In some implementations, the instructions can be received in a propagated signal, such as, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 468 using a radio frequency. In addition, short-range communication, such as using a Bluetooth or Wi-Fi, may occur. In addition, a Global Positioning System (GPS) receiver module 470 may provide additional navigation-and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in FIG. 6. For example, it may be implemented in the devices and mobile devices described with respect to FIGS. 1-5 and 7-10. Other implementations may include a phone device 482 and a tablet device 484. The mobile computing device 450 may also be implemented as a component of a smart-phone, personal digital assistant, AR device, or other similar mobile device.

Computing device 400 and/or 450 can also include USB flash drives. The USB flash drives may store operating systems and other applications. The USB flash drives can include input/output components, such as a wireless transmitter or USB connector that may be inserted into a USB port of another computing device.

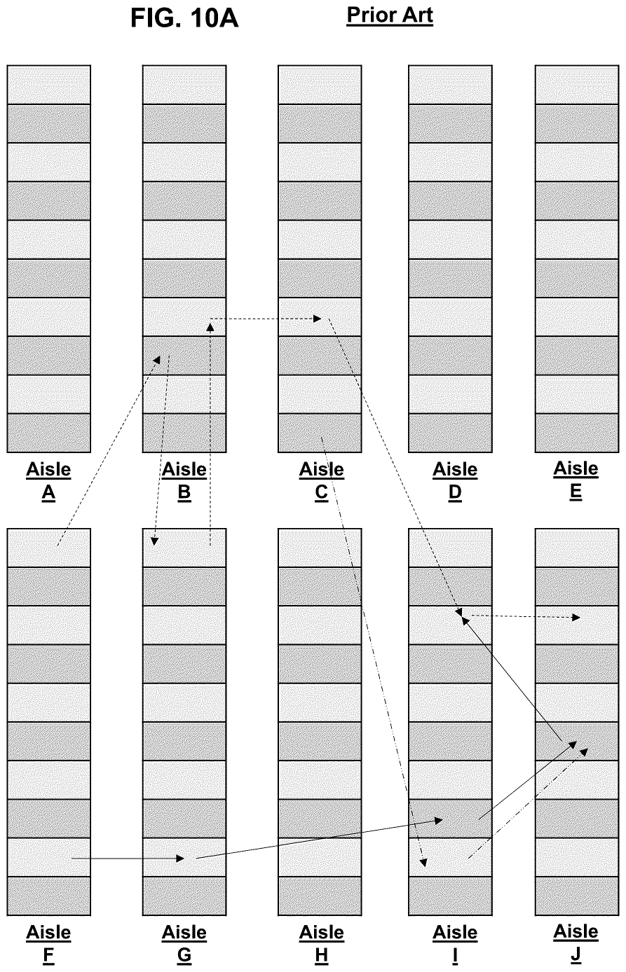

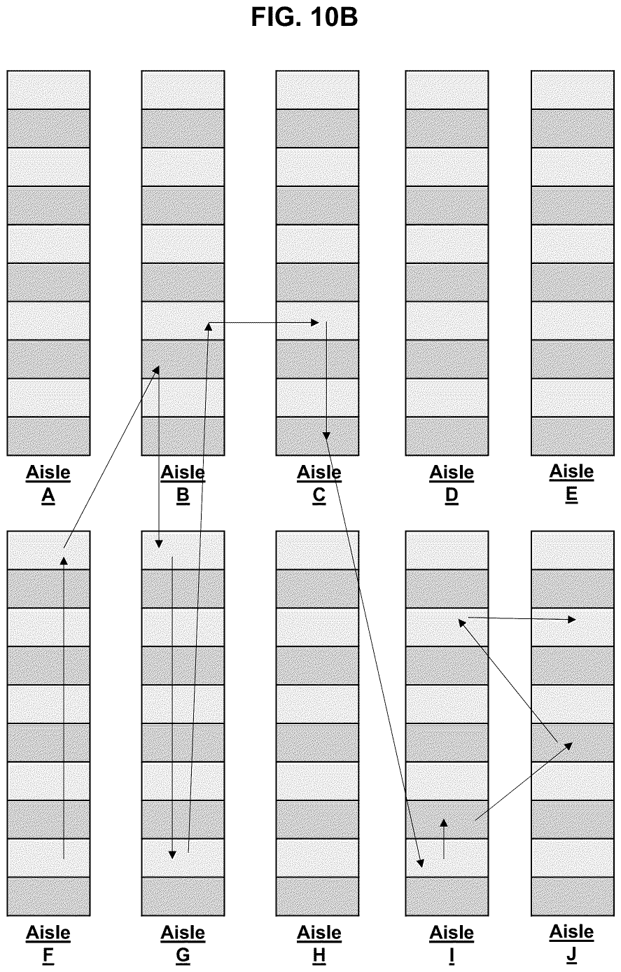

FIG. 10A is a diagram illustrating an example of multiple process paths assigned to multiple collection devices within a fulfillment center. For example, as indicated by different dashed lines, each of three pickers handle a corresponding path among three process paths for retrieving items within the picking zone 210. This approach results in increased travel distance for pickers, as they must repeatedly traverse the same aisles to fulfill different orders. By contrast, if a single picker can handle multiple process paths, the total distance traveled could be significantly reduced, thereby enhancing operational efficiency.

FIG. 10B is a diagram illustrating an example of multiple process paths assigned to a single collection device within the FC. For example, as shown by the distinct dashed lines, each of the three pickers is assigned a corresponding path among three process paths for retrieving items within the picking zone 210. This method results in increased travel distances for pickers, as they must repeatedly traverse overlapping aisles to fulfill different orders. Such redundancy in movement reduces overall efficiency, increases fatigue, and prolongs order fulfillment times.

By contrast, consolidating process paths to be handled by a single picker could significantly reduce the total distance traveled. The optimization of assigning multiple process paths to one picker minimizes redundant movements, thus enhancing operational efficiency, reducing physical strain on pickers, and potentially lowering labor costs for the FC.

FIG. 10B is a diagram illustrating an example of multiple process paths assigned to a single collection device within the FC. In some implementations, the FO system 104 can dynamically assign multiple paths to a single picker, as described in the processes outlined in FIGS. 3-5. As depicted, the travel distance per unit picked is significantly reduced because the picker can efficiently traverse through logically grouped locations.

This approach not only optimizes travel efficiency but also allows the FO system 104 to factor in additional variables such as real-time order priorities, item location density, and collection container capacity. For example, by combining process paths intelligently, the FO system 104 can ensure that the picker completes tasks within a specific zone before moving to a different area, thereby reducing overall cycle times. Moreover, this approach enables flexibility in accommodating urgent or high-priority orders without requiring additional resources or significant workflow disruption.

The integration of such dynamic assignment systems ensures scalability and adaptability within the FC operations, providing an optimal balance between human labor and automated coordination for enhanced productivity.

Although a few implementations have been described in detail above, other modifications may be made without departing from the scope of the inventive concepts described herein, and, accordingly, other implementations are within the scope of the following claims.

What is claimed is:

1. A method of order fulfillment at a fulfillment center, the method comprising:
identifying, from a list of unfulfilled orders at a fulfillment center, a plurality of item retrieval routes associated with order-items in the fulfillment center, wherein each item retrieval route represents a route for a collection device configured to collect corresponding one or more order-items and is determined based on information associated with the collection device;
identifying, based on location information of the collection device and the information, a subset of item retrieval route, among the plurality of item retrieval routes, to be assigned to the collection device for a fulfillment process such that an efficiency metric associated with the subset of item retrieval routes satisfies a threshold condition,
wherein the fulfillment process includes (i) collecting order-items within the subset of item retrieval routes from a storage area comprising multiple aisles at the fulfillment center and (ii) delivering collected order-items to a corresponding destination of each item retrieval route, and
wherein a number of item retrieval routes in the subset of item retrieval routes corresponds to a number of collection containers associated with the collection device; and
generating a signal configured to assign the subset of item retrieval routes to the collection device, the signal configured to instruct the collection device to collect the order-items in the subset of item retrieval routes using a corresponding collection container and store the collected order items in the corresponding collection container.

2. The method of claim 1, wherein the efficiency metric is based on a distance traveled per picked unit (DPU), representing a ratio of a total distance traversed by the collection device to collect the order-items in the subset of item retrieval routes to the number of order-items in the subset.

3. The method of claim 2, wherein identifying the subset of item retrieval routes comprises:
calculating the DPU for various combinations of the plurality of item retrieval routes; and
identifying the subset of item retrieval routes as a particular combination among the various combinations, such that the DPU associated with the particular combination satisfies a predetermined condition.

4. The method of claim 1, wherein the information associated with the collection device indicates accessibility of the collection device to one or more areas of the fulfillment center and a maximum number of collection containers operable by the collection device.

5. The method of claim 4, wherein identifying the plurality of item retrieval routes comprises determining a maximum number of the plurality of item retrieval routes accessible to the collection device based on the information, and
wherein the maximum number of the plurality of item retrieval routes accessible to the collection device is less than the maximum number of collection containers associated with the collection device.

6. The method of claim 1, wherein the maximum number of collection containers is determined based on a capacity of a carrier associated with the collection device, such that the capacity limits the maximum number of collection containers to be handled by the collection device.

7. The method of claim 1, wherein the subset of item retrieval routes is restricted from being assigned to another collection device.

8. A computer-implemented system for order fulfillment at a fulfillment center, the system comprising:
at least one processor; and
memory coupled to the at least one processor and storing instructions that, based on being executed by the at least one processor, perform operations comprising:
identifying, from a list of unfulfilled orders at a fulfillment center, a plurality of item retrieval routes associated with order-items in the fulfillment center, wherein each item retrieval route represents a route for a collection device configured to collect corresponding one or more order-items and is determined based on information associated with the collection device;
identifying, based on location information of the collection device and the information, a subset of item retrieval routes, among the plurality of item retrieval routes, to be assigned to the collection device for a fulfillment process such that an efficiency metric associated with the subset of item retrieval routes satisfies a threshold condition,
wherein the fulfillment process includes (i) collecting order-items within the subset of item retrieval routes from a storage area comprising multiple aisles at the fulfillment center and (ii) delivering collected order-items to a corresponding destination of each item retrieval route, and
wherein a number of item retrieval routes in the subset of item retrieval routes corresponds to a number of collection containers associated with the collection device; and
generating a signal configured to assign the subset of item retrieval routes to the collection device, the signal configured to instruct the collection device to collect the order-items in the subset of item retrieval routes using a corresponding collection container and store the collected order items in the corresponding collection container.

9. The computer-implemented system of claim 8, wherein the efficiency metric is based on a distance traveled per picked unit (DPU), representing a ratio of a total distance traversed by the collection device to collect the order-items in the subset of item retrieval routes to the number of order-items in the subset.

10. The computer-implemented system of claim 9, wherein identifying the subset of item retrieval routes comprises:
calculating the DPU for various combinations of the plurality of item retrieval routes; and
identifying the subset of item retrieval routes as a particular combination among the various combinations, such that the DPU associated with the particular combination satisfies a predetermined condition.

11. The computer-implemented system of claim 8, wherein the information associated with the collection device indicates accessibility of the collection device to one or more areas of the fulfillment center and a maximum number of collection containers operable by the collection device.

12. The computer-implemented system of claim 11, wherein identifying the plurality of item retrieval routes comprises determining a maximum number of the plurality of item retrieval routes accessible to the collection device based on the information, and
wherein the maximum number of the plurality of item retrieval routes accessible to the collection device is less than the maximum number of collection containers associated with the collection device.

13. The computer-implemented system of claim 8, wherein the maximum number of collection containers is determined based on a capacity of a carrier associated with the collection device, such that the capacity limits the maximum number of collection containers to be handled by the collection device.

14. The computer-implemented system of claim 8, wherein the subset of item retrieval routes is restricted from being assigned to another collection device.

15. A non-transitory recording medium storing a program, wherein execution of the program causes one or more computers to perform operations comprising:
identifying, from a list of unfulfilled orders at a fulfillment center, a plurality of item retrieval routes associated with order-items in the fulfillment center, wherein each item retrieval route represents a route for a collection device configured to collect corresponding one or more order-items and is determined based on information associated with the collection device;
identifying, based on location information of the collection device and the information, a subset of item retrieval routes, among the plurality of item retrieval routes, to be assigned to the collection device for a fulfillment process such that an efficiency metric associated with the subset of item retrieval routes satisfies a threshold condition,
wherein the fulfillment process includes (i) collecting order-items within the subset of item retrieval routes from a storage area comprising multiple aisles at the fulfillment center and (ii) delivering collected order-items to a corresponding destination of each item retrieval route, and
wherein a number of item retrieval routes in the subset of item retrieval routes corresponds to a number of collection containers associated with the collection device; and
generating a signal configured to assign the subset of item retrieval routes to the collection device, the signal configured to instruct the collection device to collect the order-items in the subset of item retrieval routes using a corresponding collection container and store the collected order items in the corresponding collection container.

16. The non-transitory recording medium of claim 15, wherein the efficiency metric is based on a distance traveled per picked unit (DPU), representing a ratio of a total distance traversed by the collection device to collect the order-items in the subset of item retrieval routes to the number of order-items in the subset.

17. The non-transitory recording medium of claim 16, identifying the subset of item retrieval routes comprises:
calculating the DPU for various combinations of the plurality of item retrieval routes; and
identifying the subset of item retrieval routes as a particular combination among the various combinations, such that the DPU associated with the particular combination satisfies a predetermined condition.

18. The non-transitory recording medium of claim 15, wherein the information associated with the collection device indicates accessibility of the collection device to one or more areas of the fulfillment center and a maximum number of collection containers operable by the collection device.

19. The non-transitory recording medium of claim 18, wherein identifying the plurality of item retrieval routes comprises determining a maximum number of the plurality of item retrieval routes accessible to the collection device based on the information, and
wherein the maximum number of the plurality of item retrieval routes accessible to the collection device is less than the maximum number of collection containers associated with the collection device.

20. The non-transitory recording medium of claim 15, wherein the maximum number of collection containers is determined based on a capacity of a carrier associated with the collection device, such that the capacity limits the maximum number of collection containers to be handled by the collection device.
